(19) United States
(12) Patent Application Publication
(10) Pub. No.: US 2003/0212614 A1
(43) Pub. Date: Nov. 13, 2003

(54) System and method for managing inventory

(76) Inventors: Tang Hao Chu, Tu-Chen (TW); Feng-Chia Tsao, Tu-Chen (TW); Tao Zhang, Shenzhen (CN); Hao Shen, Shenzhen (CN)

Correspondence Address: WEI TE CHUNG, FOXCONN INTERNATIONAL, INC., 1650 MEMOREX DRIVE, SANTA CLARA, CA, 95050, US

(21) Appl. No.: 10/304,419

(22) Filed: Nov. 25, 2002

(30) Foreign Application Priority Data
May 9, 2002 (TW) 91109641

(51) Int. Cl. G06F 17/60

(52) U.S. Cl. 705/28

(57) ABSTRACT

A system and method for managing inventory automatically monitors inventory amounts, provides information concerning inventory, and automatically adjusts an inventory replenishment schedule. The system includes: an inventory control unit (1) having: an inventory server (10), for controlling receipt, dispatch and storage of inventory, for integrating information received from suppliers and customers with information on current inventory amounts, and for determining if current inventory should be replenished; an inventory database (12) for storing information on suppliers, customers and inventory status; and a web server (13) for handling inquiries. A current amount of inventory is periodically monitored, and an inventory warning report is automatically generated when the amount of inventory is outside a safe range of amounts. The report is sent to the corresponding supplier, customer and/or other relevant staff by E-mail. When the supplier information system receives the report, the supplier information system automatically adjusts an inventory replenishment schedule accordingly.

### BACKGROUND OF THE INVENTION

1. Field of the Invention

The present invention relates to systems and methods for managing inventory, and more particularly to a system and method which automatically replenishes inventory according to customers' requirements.

2. Description of Related Art

Conventional inventory management systems and methods involve a large number of manually processed tasks. These systems are labor and resource intensive, and need constant management by users of the systems. For example, a manufacturer arranges production scheduling, generates long-term purchase orders, and then distributes orders to one or more suppliers. Subsequently, the suppliers prepare and ship goods to the manufacturer. This process involves many unpredictable factors, such as transportation delays and changes to production scheduling. As a result, the suppliers may not dispatch goods to the manufacturer in time. In addition, in this kind of supply chain, the suppliers have to determine their dispatch plans solely in terms of the manufacturer's order. The suppliers do not make necessary adjustments according to sales history records or predictions of future sales trends. Suppliers frequently do not have enough flexibility to ensure that the manufacturer receives the required goods in time.

Therefore a new system and method for inventory management, generally called vendor managed inventory (VMI), has been devised. VMI provides information on amounts of current inventory, historical records of inventory sales, and general market data and sales indicators. This enables a supplier to forecast future manufacturing orders, and establish an effective manufacturing schedule for continuous replenishment of inventory. VMI enables the supplier to quickly response to changes in market demand. VMI can also help the supplier to shorten lead times, and to optimize total inventory at reduced levels. Both the manufacturer and the supplier can share the same important information to anticipate future trends, manage promotion of inventory products, and schedule shipment. With VMI, replenishment orders are usually placed according to actual or anticipated demand for inventory.

VMI is widely used by suppliers, wholesalers and carriers. VMI is particularly popular for transactions between suppliers and wholesalers. Normally, suppliers determine replenishment according to wholesalers' order information. For example, U.S. Pat. No. 5,638,519 entitled Electronic Method and System for Controlling and Tracking Information Related to Business Transactions discloses a VMI method for tracking information related to business transactions between a supplier and a receiver such as a wholesaler. The business transactions are tracked via an electronic system that comprises a supplier computer at the supplier's premises, and at least one receiver computer at the receiver's premises. The method includes an initial step wherein a business controller receives and retrieves electronic information to generate updated electronic information. The updated information is stored immediately, whereupon it is accessible by the supplier and by the receiver.

Even though this VMI method can provide sharing of transaction information between the supplier and the receiver, the method cannot adequately deal with sudden changes in end customer demand encountered by the receiver. For instance, the supplier may experience an abnormally large and sudden increase in orders from various customers. The receiver may advise the supplier in real time of an increase in demand by an end customer for certain inventory. Even though the supplier receives immediate notice of the end customer's increased demand, the supplier cannot instantly fulfill such increased demand. Because of the supplier's commitment to fulfill the orders from the various customers, the supplier needs time to prepare the extra inventory for the end customer and to arrange shipment thereof. In these circumstances, the supplier may suffer delays in manufacturing and even loss of customer and end customer orders.

### SUMMARY OF THE INVENTION

Accordingly, an object of the present invention is to provide an inventory management system and method which automatically replenishes inventory so that a supplier can quickly respond to a customer's demand.

Another object of the present invention to provide an electronic system and method that enables a supplier to arrange replenishing of inventory in real time and thereby be able to promptly respond to a customer's demand.

A further object of the present invention to provide a system and method for a supplier to conveniently determine whether current inventory is outside a desired range of levels, thereby enabling the supplier to adjust inventory replenishment as necessary.

To achieve the above objects, the present invention provides an inventory management system and method for a supplier to promptly respond to a customer's demand. A preferred embodiment of the inventory management system comprises a supplier information system, a customer information system and an inventory control unit, all of which can exchange information with each other via a value added network (VAN). The inventory control unit is typically located in a warehouse, and includes: an inventory server that maintains the data and controls the processes of inventory receipt, inventory dispatch and inventory storing; a web server which receives inquiries from customers, suppliers and inventory controllers, and which provides detailed information on the processes of receipt, storing, and dispatch of inventory; an inventory database which stores information on suppliers, customers and inventory status; and an E-mail server that transmits inventory information to the supplier information system and to the customer information system. The inventory control unit generates an inventory warning report when inventory in the warehouse is outside a safe range of amounts. The report is sent to the corresponding supplier, customer and/or other relevant staff by way of E-mail. When the supplier information system receives the report, the supplier information system automatically adjusts an inventory replenishment schedule accordingly. Information on the report is also provided to the web server, for interested staff and other persons to access. The supplier can visit a web site of the web server, and adjust the inventory replenishment schedule in light of the report. The supplier is thereby likely to be able to satisfy a sudden increase in demand for inventory by the customer.

A preferred embodiment of the inventory management method comprises the following steps: (a) The customer setting a safe range of amount of inventory for every kind of inventory; (b) transmitting the safe range information to an inventory control unit; (c) the inventory control unit monitoring current amounts of inventory periodically for every kind of inventory; (d) the inventory control unit comparing current amounts of inventory with the safe range information; (e) the inventory control unit determining whether the current amounts of inventory are within the respective safety ranges; (f) returning to step (c) if the current amounts of inventory are within the respective safe ranges; (g) the inventory control unit automatically generating an inventory warning report if a current amount of inventory is not within its respective safe range; (h) the inventory control unit transmitting the report to corresponding suppliers and customers; and (i) adjusting an inventory replenishment schedule according to the report.

Other objects, advantages and novel features of the present invention will be drawn from the following detailed description of preferred embodiments of the present invention with attached drawings, in which:

### BRIEF DESCRIPTION OF THE DRAWINGS

FIG. 1 is a schematic block diagram of infrastructure of an inventory management system in accordance with the present invention, which includes an inventory control unit and a web server;

FIG. 2 is a schematic block diagram of an organizational layout of a warehouse in which the inventory control unit is typically located;

FIG. 3 is a schematic block diagram of function modules of an inventory server of the inventory control unit;

FIG. 4 is a schematic block diagram of a process of transmitting EDI information in accordance with the present invention;

FIG. 5 is a flow chart of a process of receiving inventory in the warehouse in accordance with the present invention;

FIG. 6 is a flow chart of a process of dispatching inventory from the warehouse in accordance with the present invention;

FIG. 7 is a flow chart of a process of generating an inventory warning report in accordance with the present invention; and

FIG. 8 is a schematic block diagram of function modules of the web server.

### DETAILED DESCRIPTION OF THE INVENTION

Preferred embodiments of the present invention will now be explained with reference to the accompanying drawings.

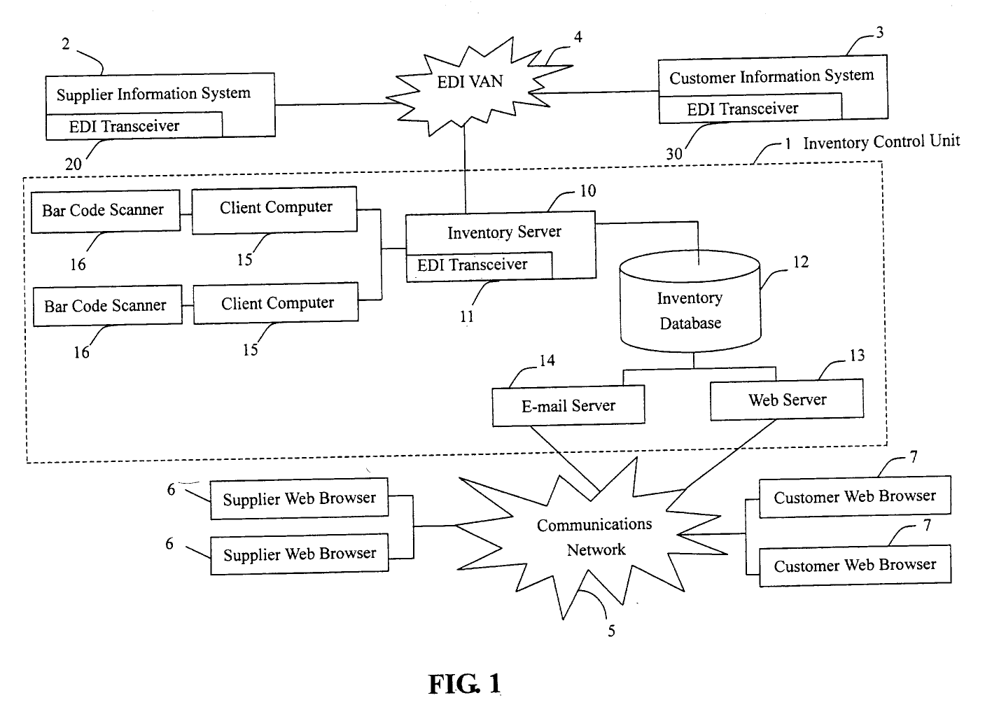

FIG. 1 is a schematic block diagram of infrastructure of an inventory management system in accordance with the present invention. The inventory management system comprises an inventory control unit 1, at least one supplier information system 2, and at least one customer information system 3. Each supplier information system 2 comprises an EDI transceiver 20 that can transmit and receive all kinds of information including information on inventory receipt, inventory dispatch, inventory storage, inventory invoicing and other related information.

Each customer information system 3 can be a Management Information System (MIS) of an enterprise, such as Manufacture Resource Planning II (MRPII) or Enterprise Resource Planning (ERP). Each customer information system 3 comprises an EDI transceiver 30 that transmits and receives all kinds of information via an EDI value added network (VAN) 4.

The inventory control unit 1 is typically located in a warehouse, and includes an inventory server 10, an inventory database 12, an E-mail server 14, a web server 13 and a plurality of client computers 15. The. client computers 15 are separately installed at various cargo entrances of the warehouse, and are connected with the inventory server 10 via an intranet (not labeled). Each client computer 15 is connected with a respective bar code scanner 16. The bar code scanner 16 scans bar codes on packages and boxes of inventory, and transmits the bar code information to the inventory database 12 via the inventory server 10. The connection of the client computer 15 to the inventory server 10 is a typical two-layer (client-server) model. The client computer 15 carries out a series of related operations via the inventory server 10.

The inventory server 10 stores inventory information in and retrieves inventory information from the inventory database 12 via the intranet.

The inventory management system further comprises at least one supplier web browser 6 and at least one customer web browser 7. The supplier and customer web browsers 6, 7 can be Internet Explorer (a browser of Microsoft) or Navigator (a browser of Netscape). Suppliers and customers can inquire of relevant information concerning status of inventory via a communications network 5. The web server 13 is connected with the inventory database 12, and retrieves the information stored in the inventory database 12 via the intranet. Customers can visit the web site of the web server 13 using the customer web browsers 7, and can send inquiries to the inventory database 12. The inventory database 12 analyzes the inquiries and transmits responses to the web server 13. Hence, the customers can obtain the needed information.

The inventory control unit 1 also comprises an E-mail server 14 that can transmits an inventory warning report and an inventory storage duration report to corresponding suppliers and customers served by the inventory control unit 1. The inventory warning report and inventory storage duration report are described in detail later on.

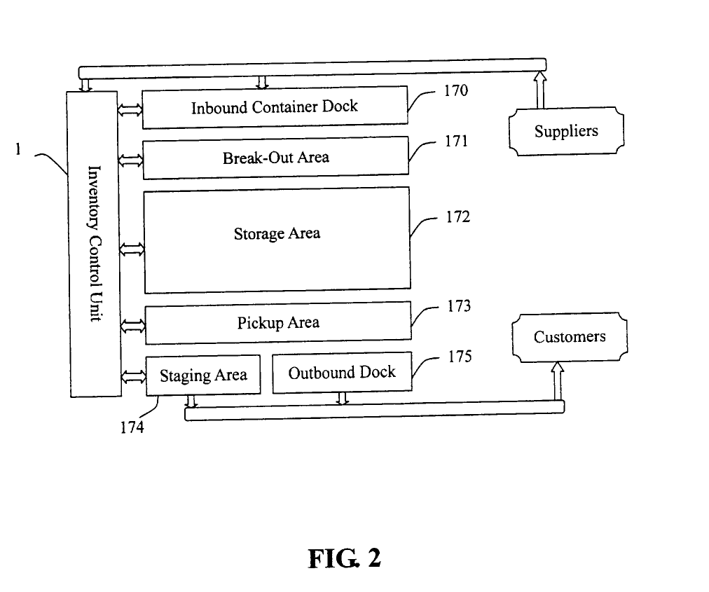

FIG. 2 is a schematic block diagram of an organizational layout of the warehouse. Typically, the warehouse is located near a location of a customer, making it convenient to deliver inventory to the customer. The warehouse comprises six main areas: an inbound container dock 170, a break-out area 171, a storage area 172, a pickup area 173, a staging area 174 and an outbound dock 175. The break-out area 171 is used for temporarily storing offloaded inbound inventory. Generally, inventory flows from a supplier to a customer through these six main areas. The inventory control unit 1 manages the processes of receiving, storing and dispatching inventory.

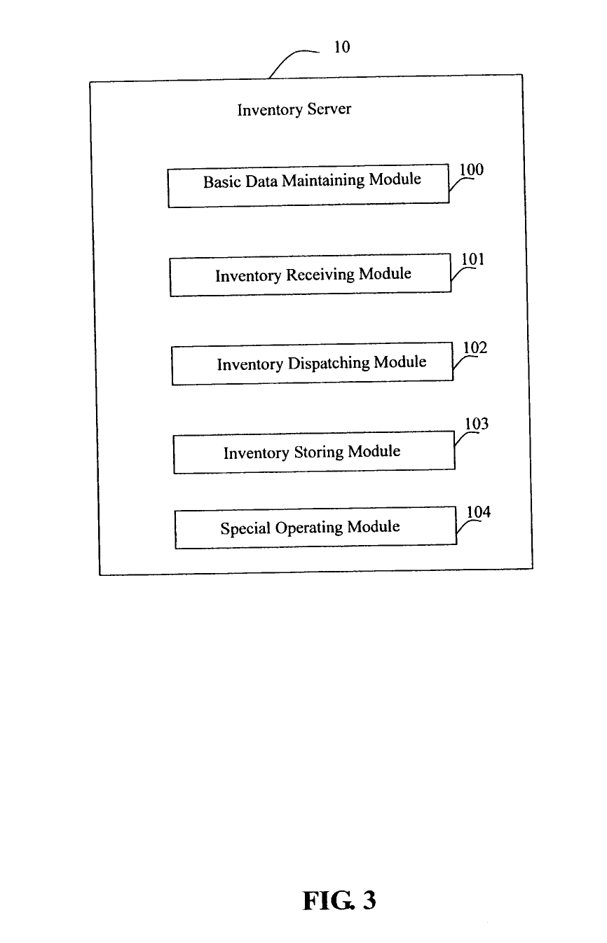

FIG. 3 is a schematic block diagram of function modules of the inventory server 10. The inventory server 10 comprises a basic data maintaining module 100, an inventory receiving module 101, an inventory dispatching module 102, an inventory storing module 103, and a special operating module 104. The basic data maintaining module 100 is used for maintaining basic data of the inventory management system, including defining data, creating data, modifying data, adding data, deleting data and inquiring of data. All basic data are stored in the inventory database 12.

The inventory receiving module 101 is used for dealing with operation information involved in receiving inventory from a supplier, including creating acceptance invoices, recording received inventory and generating inquiry reports. The inventory dispatching module 102 is used for dealing with operation information involved in dispatching inventory from the warehouse to a customer, including creating shipping lists, dispatching inventory and generating dispatch inquiry reports. The inventory storing module 103 is used for controlling internal inventory operations, including relocating inventory, checking inventory and generating inventory inquiry reports. The special operating module 104 is used for performing special operations, including rejecting inventory, returning inventory and reprinting reports.

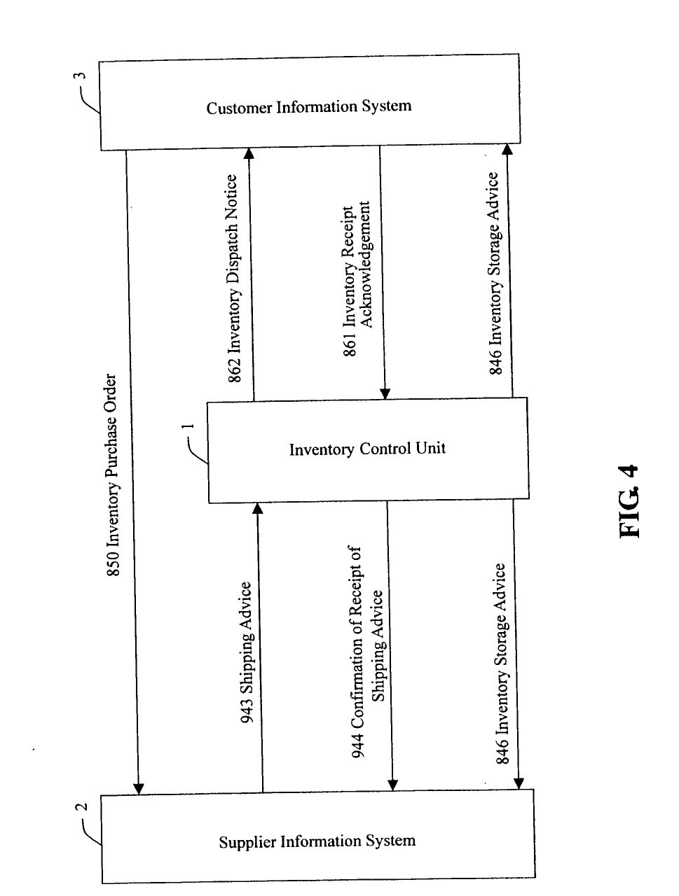

FIG. 4 is a schematic block diagram of a process of transmitting EDI information in accordance with the present invention. In the preferred embodiment of the present invention, an EDI service supplier (not shown) provides EDI format transferring and transmitting services for the supplier, customer and warehouse. The EDI information that is transmitted and received by the EDI transceivers 11, 20, 30 of the inventory management system are handled by the EDI service supplier. For the sake of brevity, steps performed by the EDI service supplier are omitted from the following description.

Firstly, the customer information system 3 transmits an inventory purchase order 850 message to the supplier information system 2. The supplier information system 2 then transmits a shipping advice 943 message to the inventory control unit 1. The inventory control unit 1 thereupon transmits a confirmation of receipt of shipping advice 944 message to the supplier information system 2. Subsequently, the inventory control unit 1 transmits an inventory dispatch notice 862 message to the customer information system 3. Subsequently, the customer information system 3 transmits an inventory receipt acknowledgement 861 message to the inventory control unit 1. The inventory control unit 1 then calculates current inventory stored in the warehouse, and transmits an inventory storage advice 846 message to both the supplier information system 2 and the customer information system 3.

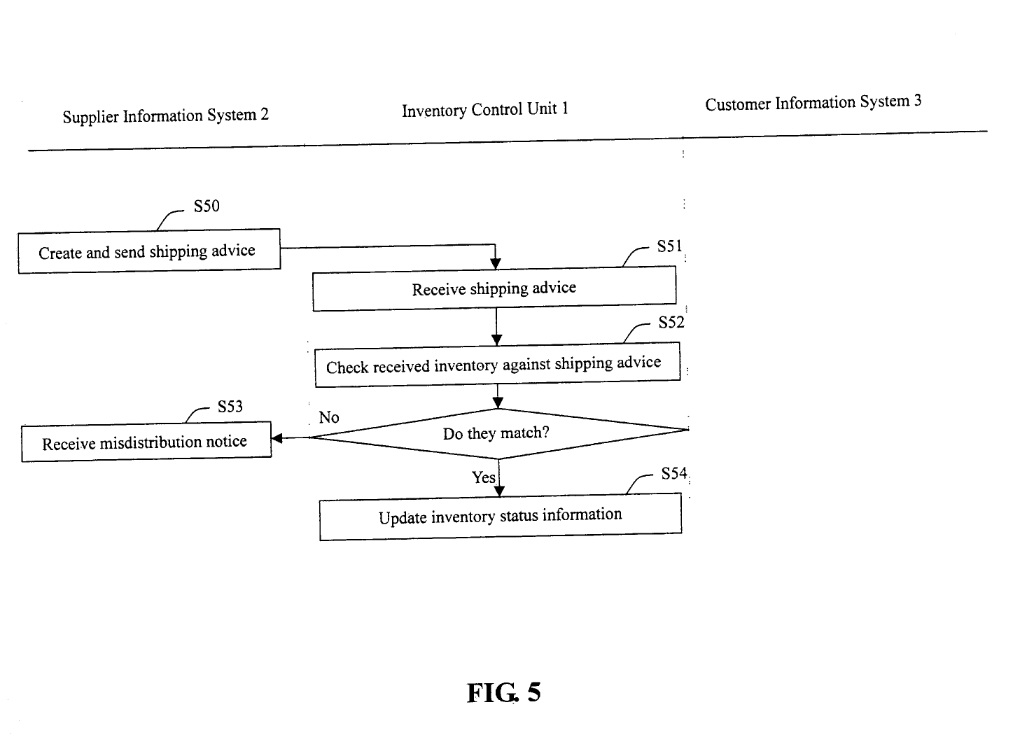

FIG. 5 is a flow chart of a process of receiving inventory in the warehouse in accordance with the present invention. Firstly, in step S50, the supplier information system 2 generates a shipping advice. The shipping advice is generated according to a purchase order of a customer, a production schedule for the customer, and an inventory status in the warehouse corresponding to the purchase order. Then the shipping advice is transmitted to the EDI transceiver 11 of the inventory control unit 1. In step S51, the inventory control unit 1 receives the shipping advice. Subsequently, an inventory controller checks a status of utilization of inventory in the warehouse, and checks and prepares the warehouse's resources accordingly. The status of utilization of inventory includes how long items of inventory have been stored in the warehouse to date, and whether the inventory stored is still usable. The warehouse resources include inventory operators, current status of movement of inventory from suppliers and to customers, and current occupancy or vacancy of various parts of the storage area 172. The inventory receiving module 101 of the inventory server 10 generates a confirmation of receipt of shipping advice. The inventory controller confirms the shipping advice by transmitting the confirmation of receipt of shipping advice to the supplier information system 2, and then waits for the supplier (or its carrier) to ship the inventory to the inbound container dock 170.

In step S52, when the inventory is dropped off at the inbound container dock 170, an inventory operator checks the inventory against the received shipping advice to determine whether the inventory matches the shipping advice. In step S53, if the inventory does not match the shipping advice, then an EDI misdistribution notice is sent to the supplier information system 2 for a determination on whether to accept or reject the inventory. If the inventory matches the shipping advice, then in step S54 the inventory status information in the inventory database 12 is automatically updated. The inventory is then unloaded and stored in an appropriate part of the storage area 172. The inventory control unit 1 generates individual bar codes for each package and box of the inventory. Each bar code contains detailed information on the inventory, including its supplier, customer and arrival date. The bar code information is printed on labels that are attached to such packages and boxes.

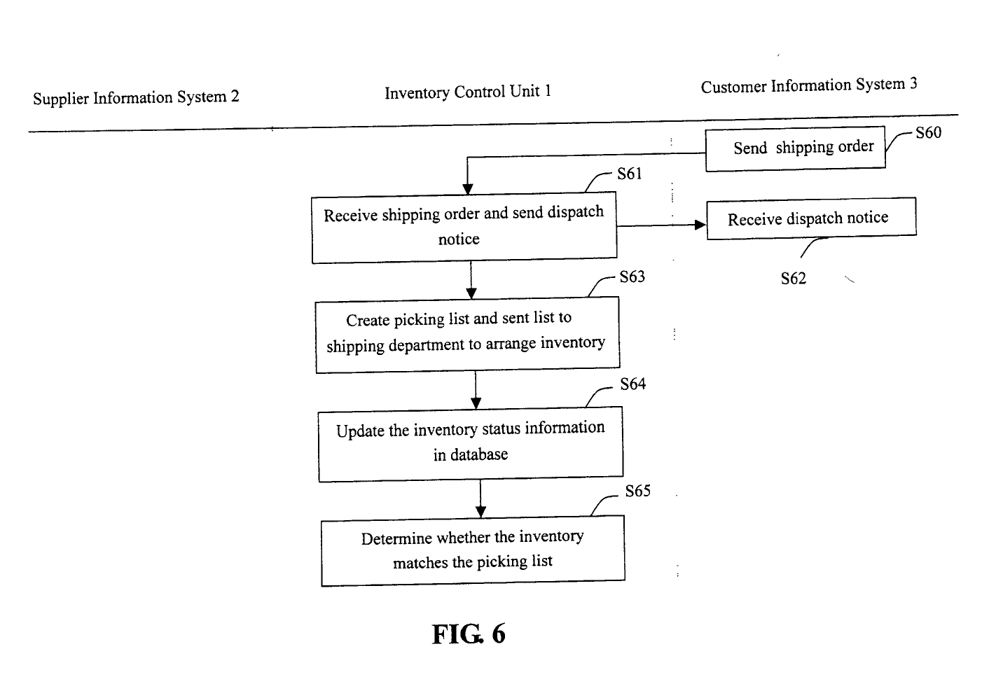

FIG. 6 is a flow chart of a process of dispatching inventory from the warehouse in accordance with the present invention. Firstly, in step S60, the customer information system 3 transmits a shipping order to the inventory control unit 1. In step S61, the inventory control unit 1 receives the shipping order. Then the inventory dispatching module 102 of the inventory server 10 generates an inventory dispatch notice, and transmits the inventory dispatch notice to the customer information system 3. In step S63, the inventory control unit 1 arranges a dispatch schedule according to the shipping order and a current status of warehouse resources. The warehouse resources include inventory operators, and current status of distribution of inventory from suppliers and to customers. A picking list is generated, and sent to a shipping department of the warehouse to arrange transfer of inventory from the storage area 172. In step S64, the inventory controller arranges transfer of the inventory from the storage area 172 to the pickup area 173, and the inventory status information is automatically updated in the inventory database 12. In step S65, the inventory controller determines whether the inventory matches the picking list. If the inventory matches the picking list, the inventory operator scans the bar codes of the packages and boxes of inventory with the bar code scanner 16. The bar code scanner 16, which is connected with the client computer 15, stores the collected data in the inventory database 12. Thereupon, the inventory dispatching module 102 changes the status of the inventory and handles required dispatch documents. Finally, the inventory operator dispatches the inventory to the customer.

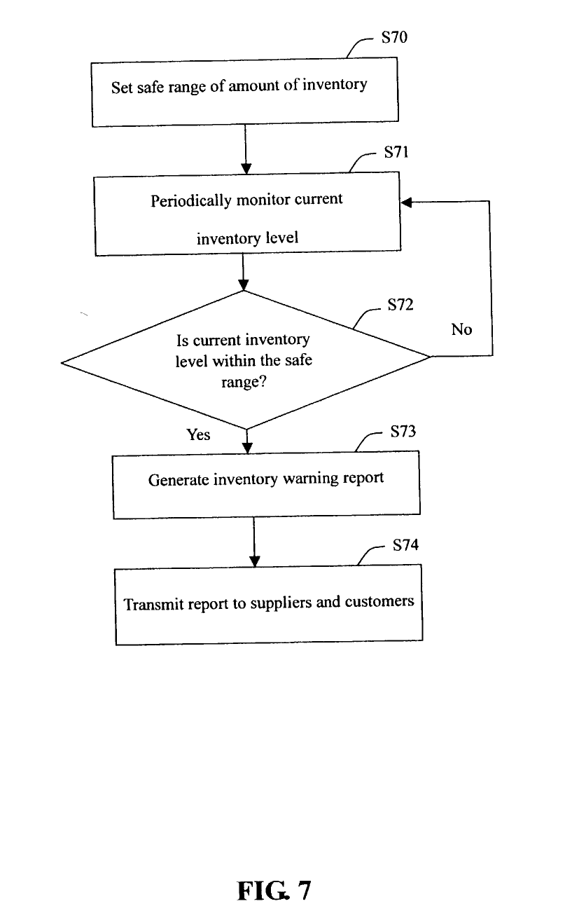

FIG. 7 is a flow chart of a process of generating the inventory warning report in accordance with the present invention. Firstly, in step S70, the customer information system 3 sets a safe range of amount of inventory for every kind of inventory, according to manufacturing schedules and a historical status of utilization of every kind of inventory. The historical status of utilization of inventory includes a history of how long items of inventory have been stored in the warehouse, and how long each kind of inventory can be stored and still be usable. The safe range of inventory amounts has a minimum level and a maximum level, so as to maintain inventory of the warehouse at acceptable quantities. In step S71, the inventory control unit 1 periodically monitors a current inventory level for every kind of inventory. The current inventory level includes total amount of inventory in storage, and total amount of inventory on order. Such periodic monitoring can be set at regular intervals such as every half-day, every day, every three days, etcetera. In step S72, the inventory control unit 1 determines whether the current level of inventory is within the preset safe range. In step S73, if the current level of inventory is within the preset safe range, the procedure returns to step S71 for the next periodic monitoring. If the current level of inventory is outside the preset safe range, that is, above the maximum level or below the minimum level, then the inventory control unit 1 generates an inventory warning report that lists detailed information about the inventory. Such information includes information on the supplier, the customer, the preset safe range and the current inventory level. Finally, in step S74 the inventory control unit 1 transmits the inventory warning report to the corresponding supplier, customer and/or other relevant staff by way of E-mail. Information on the inventory warning report is also provided to the web server 13, for interested staff and other persons to access. When the supplier information system 2 receives the inventory warning report, the supplier information system 2 automatically adjusts an inventory replenishment schedule accordingly. For example, if the current level of inventory is above the maximum level, a frequency of receiving inventory in the warehouse is reduced. Conversely, if the current level of inventory is below the minimum level, a frequency of receiving inventory in the warehouse is increased.

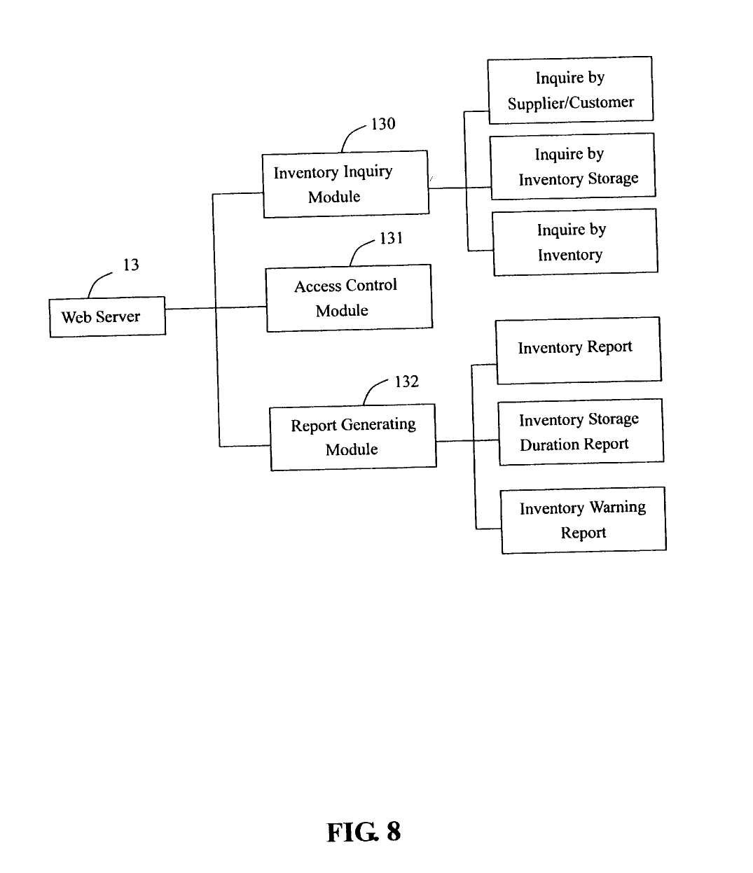

FIG. 8 is a schematic block diagram of function modules of the web server 13. The web server 13 is connected with the inventory database 12, and comprises three modules: an inventory inquiry module 130, a report generating module 132, and an access control module 131. The inventory inquiry module 130 is provided for customers to inquire of information in the inventory database 12 according to supplier name, customer name, storage area, invoice number, or category of inventory. For example, the inventory controller can inquire of a current location and amount of a particular inventory. The inquiry result is displayed in the form of an appropriate report that is generated by the report generating module 132. In addition, the report generating module 132 can also generate the inventory warning report and the inventory storage duration report. The inventory storage duration report lists details of analysis for every kind of inventory in the warehouse, including how long each item of inventory has been stored in the warehouse to date. The access control module 131 sets access privileges for users, and verifies users' identities. For example, a supplier can inquire of inventory information of other related suppliers via the web server 13. It is very convenient for customers to obtain information on inventory via the web server 13.

Although detailed embodiments are described herein, it should be understood that they do not limit the present invention. Various changes, substitutions and alterations can be made to the embodiments by those skilled in the art without departing form the spirit and scope of the invention as defined by the appended claims.

What is claimed is:

1. A system for managing inventory, the system comprising:
an inventory control unit for controlling receipt, dispatch and storage of inventory at a warehouse, the inventory control unit comprising:
an inventory server comprising an EDI transceiver for exchanging EDI information and for recording receipt, dispatch and storage of inventory;
a web server for handling customer inquiries and providing inventory status information; and
an inventory database respectively connected with the inventory server and the web server, for storing information on suppliers, customers and inventory status, and for responding to requests from the inventory server and the web server;
a supplier information system comprising an EDI transceiver for exchanging EDI information; and
a customer information system comprising an EDI transceiver for exchanging EDI information.

2. The system for managing inventory according to claim 1, further comprising an E-mail server connected with the inventory database for transmitting information in the inventory database to the supplier information system and the customer information system.

3. The system for managing inventory according to claim 1, further comprising at least one supplier browser for at least one supplier to visit the web server and request information from the web server.

4. The system for managing inventory according to claim 1, further comprising at least one customer browser for at least one customer to visit the web server and request information from the web server.

5. The system for managing inventory according to claim 1, wherein the inventory control unit further comprises at least one client computer for collecting information on received inventory via a bar code scanner.

6. The system for managing inventory according to claim 1, wherein the inventory server further comprises an inventory receiving module for dealing with operation information involved in receiving inventory at the warehouse, an inventory dispatching module for dealing with operation information involved in dispatching inventory from the warehouse, an inventory storing module for controlling internal inventory operations, and a special operating module for performing special operations.

7. The system for managing inventory according to claim 1, wherein the EDI information comprises inventory purchase information, shipping advice information, conformation of receipt information, inventory receipt acknowledgment information, and inventory storage information.

8. The system for managing inventory according to claim 2, wherein the information transmitted by the E-mail server is an inventory warning report.

9. The system for managing inventory according to claim 2, wherein the information transmitted by the E-mail server is an inventory storage duration report.

10. A method for managing inventory, the method comprising the steps of:
(a) setting a safe range of amount of inventory for respective kinds of inventory;
(b) transmitting the safe range information to an inventory control unit;
(c) monitoring current amounts of inventory periodically for respective kinds of inventory;
(d) comparing current amounts of inventory with the safe range information;
(e) determining whether the current amounts of inventory are within the respective safe ranges;
(f) returning to step (c) if the current amounts of inventory are within the respective safe ranges;
(g) generating an inventory warning report automatically via the inventory control unit if a current amount of inventory is not within its respective safe range; and
(h) transmitting the inventory warning report.

11. The method for managing inventory according to claim 10, wherein in step (h) the transmitting is done by way of E-mail.

12. The method for managing inventory according to claim 10, wherein in step (h) the report is transmitted to at least one supplier, at least one customer, and/or any other concerned person.

13. The method for managing inventory according to claim 10, further comprising the step of:
adjusting an inventory replenishment schedule according to the inventory warning report.

14. The method for managing inventory according to claim 10, wherein the safe range is set according to manufacturing schedules and a historical status of utilization of respective kinds of inventory.

15. The method for managing inventory according to claim 13, wherein the step of adjusting an inventory replenishment schedule comprises the step of:
increasing a frequency of inventory replenishment.

16. The method for managing inventory according to claim 13, wherein the step of adjusting an inventory replenishment schedule comprises the step of:
decreasing a frequency of inventory replenishment.

17. A method of managing inventory comprising steps of:
(1) setting a time period to evaluate inventory amount according to transaction frequency;
for each evaluation the method including the steps of;
(2) setting a safe range of amount of inventory for each respective inventory according to transaction frequency;
(3) comparing a current amount of a specific inventory with the corresponding safe range;
(4) repeating step (3) if the current amount is within the safe range, or if not,
(5) automatically generating a warning report for replenishment and transmitting said report to an inventory manager.
